(19) United States
(12) Patent Application Publication
(10) Pub. No.: US 2026/0370815 A1
(43) Pub. Date: Nov. 19, 2026

(54) HISTORY-BASED INTRA PREDICTION MODE

(71) Applicant: InterDigital CE Patent Holdings, SAS, Paris (FR)

(72) Inventors: Ya Chen, Rennes (FR); Karam Naser, Mouazé (FR); Edouard Francois, Bourg des Comptes (FR); Didier Doyen, Cesson-Sévigné (FR)

(73) Assignee: InterDigital CE Patent Holdings, SAS, Paris (FR)

(21) Appl. No.: 19/142,586

(22) PCT Filed: Dec. 23, 2023
(86) PCT No.: PCT/EP2023/087589

§ 371 Date: Jun. 23, 2025

(30) Foreign Application Priority Data
Dec. 23, 2022 (EP) 22307022.8

(51) Int. Cl. H04N 19/11; H04N 19/176; H04N 19/593

(52) U.S. Cl. CPC H04N 19/11; H04N 19/176; H04N 19/593

(57) ABSTRACT

Systems, methods, and instrumentalities are disclosed for performing video coding using a history-based intra prediction mode (HIPM). A video decoding device may identify, for a current block, an intra-predicted neighboring block that is separated from the current block by at least a block. The device may determine an intra prediction mode of the intra-predicted neighboring block. The device may decode the current block based on the intra prediction mode of the intra-predicted neighboring block.

### CROSS REFERENCE TO RELATED APPLICATIONS

This application claims the benefit of European Provisional Patent Application No. 22307022.8, filed Dec. 23, 2022, the contents of which are hereby incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for performing video coding using a history-based intra prediction mode (HIPM). A video decoding device may identify, for a current block, an intra-predicted neighboring block that is separated from the current block by at least a block. The device may determine an intra prediction mode of the intra-predicted neighboring block. The device may decode the current block based on the intra prediction mode of the intra-predicted neighboring block.

A video encoding device may identify, for a current block, an intra-predicted neighboring block that is separated from the current block by at least a block. The device may determine an intra prediction mode of the intra-predicted neighboring block. The device may encode the current block based on the intra prediction mode of the intra-predicted neighboring block.

The device (e.g., the video decoding device and/or the video encoding device) may add the intra prediction mode of the intra-predicted neighboring block to a most probable mode (MPM) list associated with the current block. The device may encode and/or decode the current block based on the MPM list.

The device may add the intra prediction mode of the intra-predicted neighboring block to a history-based intra prediction mode (HIPM) table. The HIPM table may include multiple HIPM candidates. The device may obtain an MPM list associated with the current block based on the HIPM table. The device may encode and/or decode the current block based on the MPM list.

The device may obtain an HIPM table that includes multiple HIPM candidates. The device may determine whether the intra prediction mode of the intra-predicted neighboring block is identical to an HIPM candidate in the HIPM table. Based on determining that the intra prediction mode of the intra-predicted neighboring block is identical to an HIPM candidate in the HIPM table, the device may remove the identical HIPM candidate from the HIPM table. The device may move each of HIPM candidates in the HIPM table that were behind the identical HIPM candidate before removing the identical HIPM candidate. The device may add the intra prediction mode of the intra-predicted neighboring block to a designated entry in the HIPM table.

The device may determine that the intra prediction mode of the intra-predicted neighboring block is distinguishable from HIPM candidates in an HIPM table. Based on the determination, the device may remove a first HIPM candidate from the HIPM table. The device may move the HIPM candidates in the HIPM table that were behind the first HIPM candidate before removing the first HIPM candidate. The device may add the intra prediction mode of the intra-predicted neighboring block to a designated entry in the HIPM table.

The device may determine that the intra prediction mode of the intra-predicted neighboring block is identical to an HIPM candidates in an HIPM table. Based on the determination, the device may increase a significance of the identical HIPM candidate. The device may reorder the HIPM table.

The device may determine that the intra prediction mode of the intra-predicted neighboring block is distinguishable from HIPM candidates in an HIPM table. Based on the determination, the device may remove a first HIPM candidate from the HIPM table. The device may add the intra prediction mode of the intra-predicted neighboring block in the HIPM table. The device may reorder the HIPM table.

Systems, methods, and instrumentalities described herein may involve a decoder. In examples, the systems, methods, and instrumentalities described herein may involve an encoder. In examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 illustrates an example of generating intra prediction samples using reference samples obtained from reconstructed samples of neighboring blocks.

FIG. 6 illustrates an example of intra prediction modes.

FIG. 7 illustrates an example of generating an intra prediction signal.

FIG. 8 illustrates an example of generating intra mode predictors for a predictor block.

FIGS. 9A and 9B illustrate an example of deriving decoder-side intra mode derivation (DIMD) prediction modes from histogram of gradients (HOG) bins.

FIG. 10 illustrates an example of template-based intra prediction mode (TIMD).

FIGS. 11A and 11B illustrate an example of spatial geometric partition mode (SGPM).

FIG. 12 illustrates an example of multiple reference line (MRL) intra prediction.

FIGS. 13A and 13B illustrate an example of intra sub partitions (ISPs).

FIG. 14 illustrates an example of signaling an intra prediction mode selected to predict the luma component of a current coding unit (CU).

FIGS. 15A and 15B illustrate an example of a multiple prediction mode (MPM) list.

FIG. 16 illustrates an example of neighboring blocks relative to a current block.

FIG. 17A illustrates an example of merge candidate list construction with history based motion vector prediction (HMVP) candidates.

FIG. 17B illustrates an example of advanced motion vector prediction (AMVP) candidate list construction with history-based motion vector prediction (HMVP) candidates.

FIG. 18 illustrates an example of occlusion.

FIG. 19 illustrates an example of history-based intra prediction mode (HIPM) coding.

FIG. 20 illustrates an example of HIPM table maintenance.

FIG. 21 illustrates an example of an order of entries in an HIPM table.

FIG. 22 illustrates an example of adding to a table an HIPM candidate from the available spatial neighboring blocks of a current block's spatial neighboring blocks.

FIG. 23 illustrates an example of a reference region with intra prediction mode(s) that may be appended in an HIPM table.

FIG. 24 illustrates an example of application of a reference region of intra block copy (IBC) for HIPM.

FIG. 25 illustrates an example of using HIPM in an MPM list construction process.

FIG. 26 illustrates an example of using HIPM candidates stored in an HIPM table to fill in a secondary MPM (SMPM) list.

FIG. 27 illustrates an example of signaling of an intra prediction mode selected to predict the luma component of a current CU.

### DETAILED DESCRIPTION

A more detailed understanding may be had from the following description, given by way of example in conjunction with the accompanying drawings.

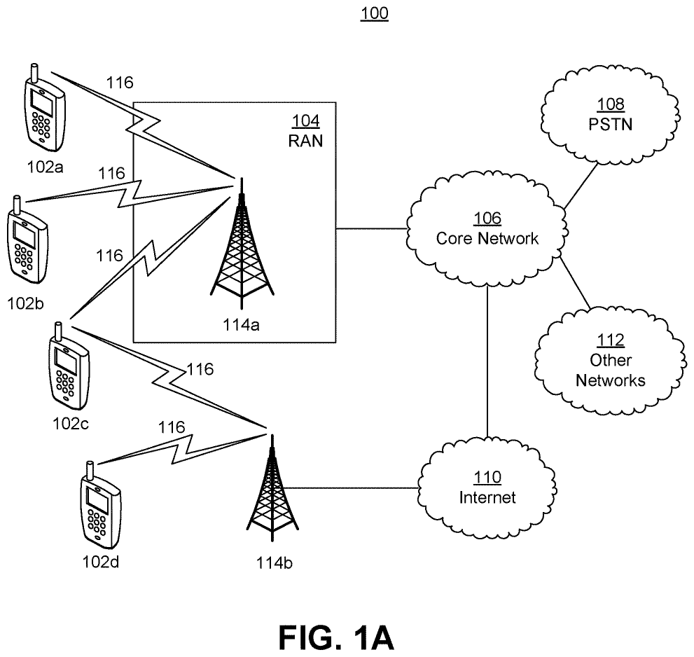

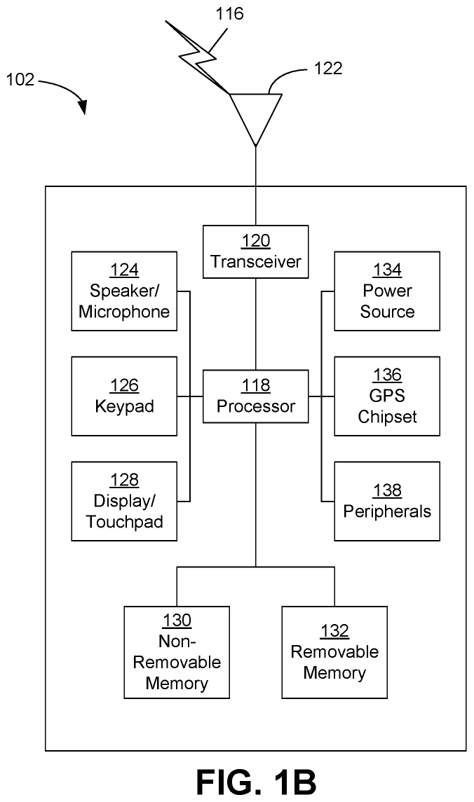

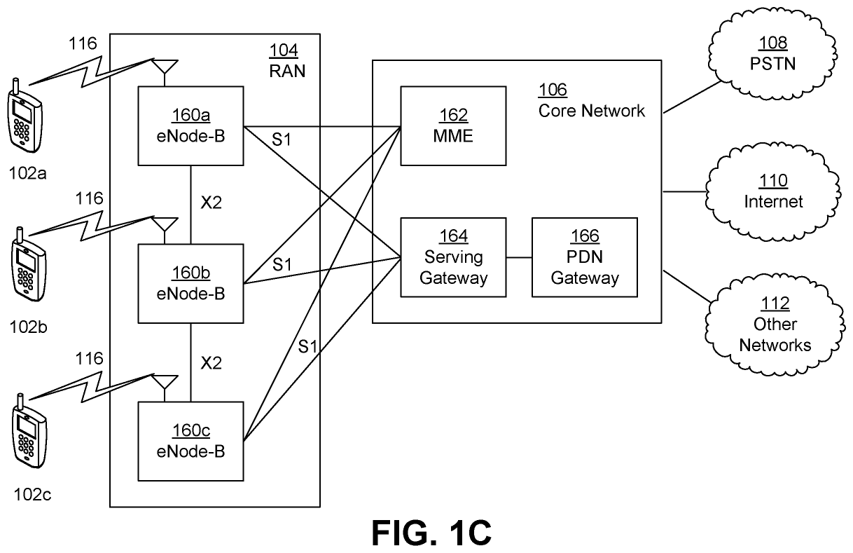

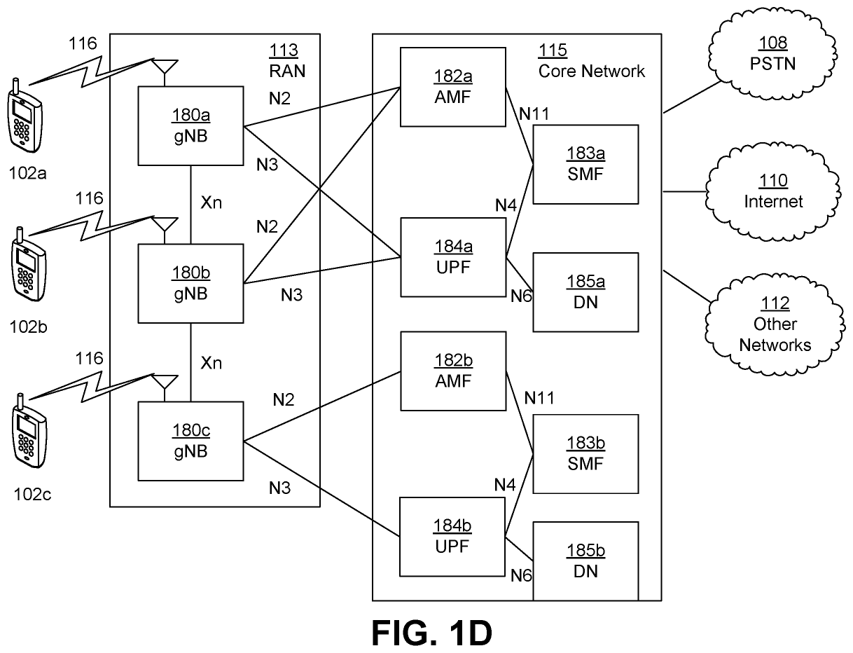

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

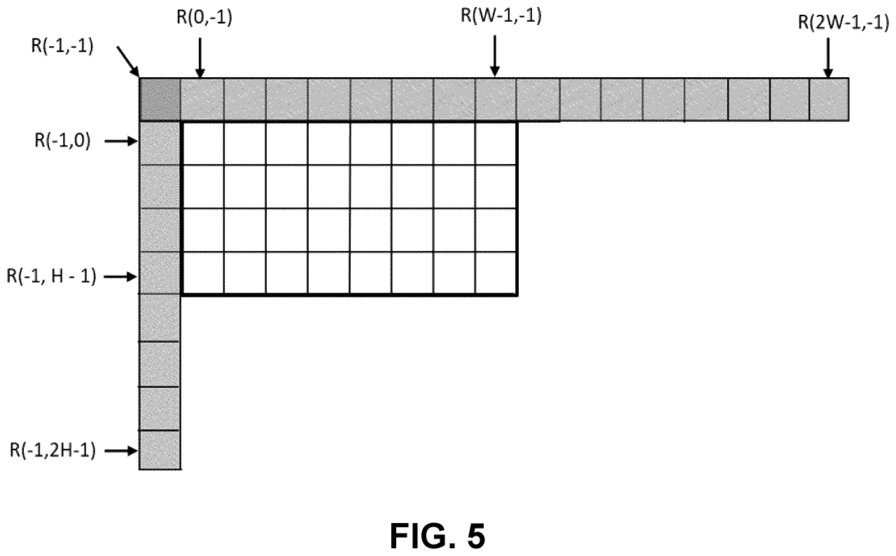

The aspects described and contemplated in this application may be implemented in many different forms. FIGS. 5-27 described herein may provide some examples, but other examples are contemplated. The discussion of FIGS. 5-27 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

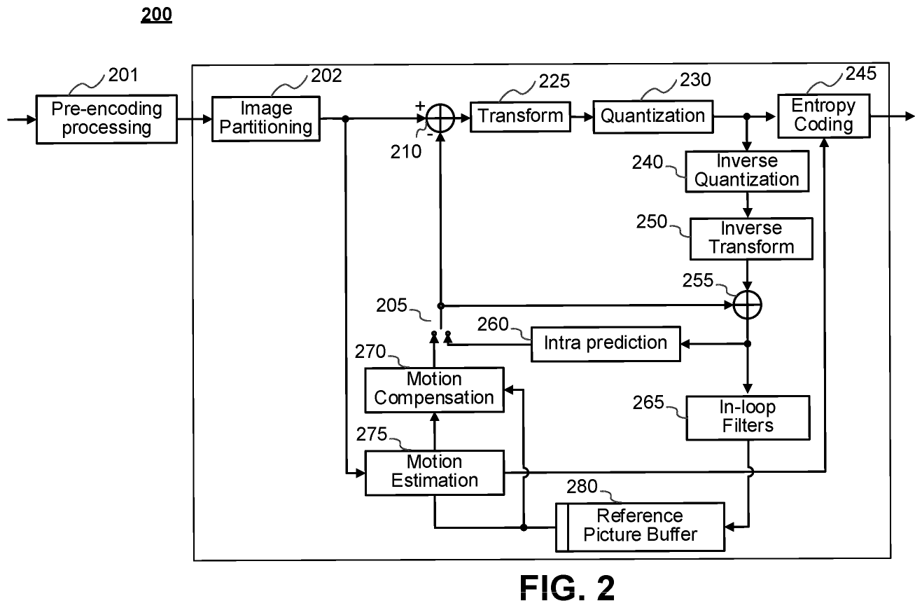

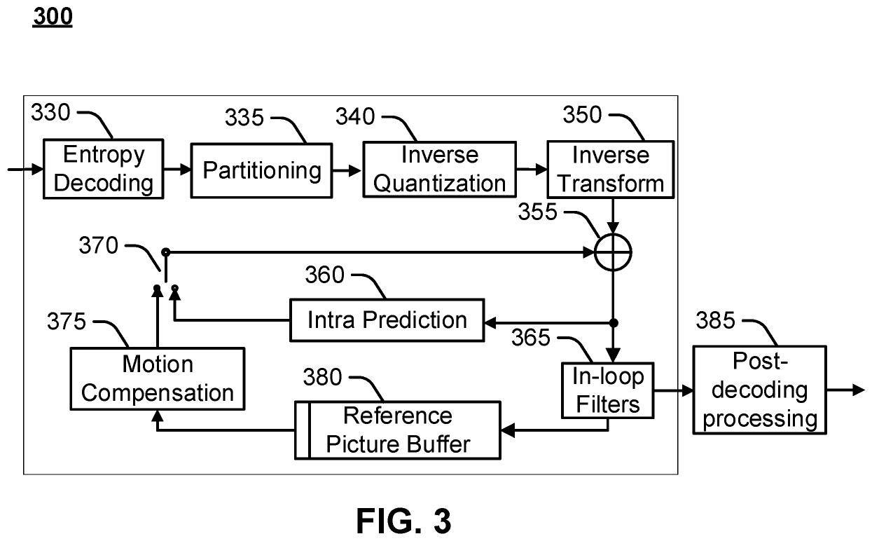

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as the number of intra modes, video codec attributes (e.g., version of a video codec), intra prediction direction angles, number of HOG bins, table size, number of candidates, block sizes, etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components).

Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag (e.g., indication).

Prediction residuals are calculated, for example, by subtracting (210) the predicted block from the original image block.

The prediction residuals are then transformed (225) and quantized (230). The quantized transform coefficients, as well as motion vectors and other syntax elements, such as picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filtering) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380). In examples (e.g., for a given picture) the contents of the reference picture buffer 380 on the decoder 300 side may be identical to the contents of the reference picture buffer 280 on the encoder 200 side (e.g., for the same picture).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

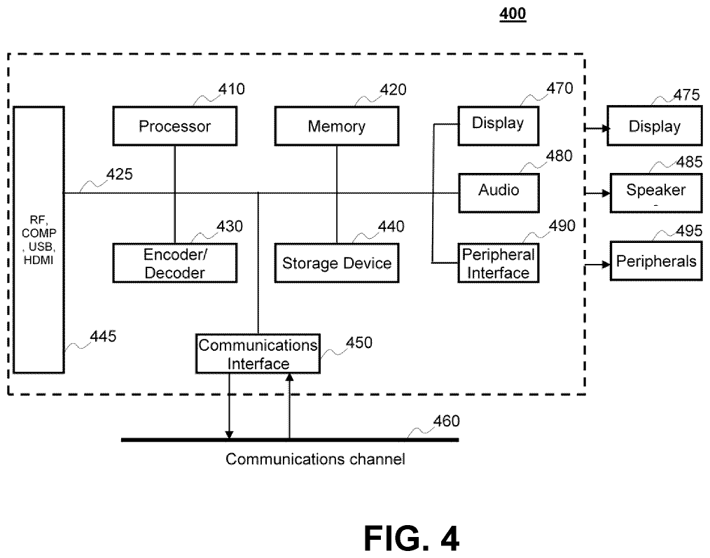

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers.

Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV. Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, for a current block, identifying an intra-predicted neighboring block that is separated from the current block by at least a block; determining an intra prediction mode of the intra-predicted neighboring block; and decoding the current block based on the intra prediction mode of the intra-predicted neighboring block.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, for a current block, identifying an intra-predicted neighboring block that is separated from the current block by at least a block; determining an intra prediction mode of the intra-predicted neighboring block; and encoding the current block based on the intra prediction mode of the intra-predicted neighboring block.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, such as indications and/or flags (e.g., mip_flag, dimd_flag, timd_flag, sgpm_flag, isp_flag, hipm_flag) , indices (e.g., mip_mode, sgpm_cand_idx, mrl_index, hipm_idx), etc., are descriptive terms. As described herein, the terms flag and indication may be used interchangeably. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, flags (e.g., mip_flag, dimd_flag, timd_flag, sgpm_flag, isp_flag, hipm_flag) , indices (e.g., mip_mode, sgpm_cand_idx, mrl_index, hipm_idx), etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

Video compression may be implemented using an intra prediction mode, e.g., a history-based intra prediction mode (HIPM). As described herein, an HIPM table may be constructed. HIPM may be used to determine luma/chroma components. HIPM may modify compression efficiency, e.g., by reducing the bitrate while maintaining quality, and/or by improving compressed video quality while maintaining the bitrate.

Video codecs may use intra prediction to remove correlation within local regions of a picture. Intra prediction may be implemented based on an assumption that a texture of a picture region is similar to the texture in a local neighborhood, allowing prediction. Direct neighbor samples may be employed for prediction. Direct neighbor samples may include, for example, samples from the sample line above the current block and samples from the last column of the reconstructed blocks to the left of the current block.

Intra prediction samples may be generated using reference samples obtained from reconstructed samples of neighboring blocks.

FIG. 5 illustrates an example of generating intra prediction samples using reference samples obtained from reconstructed samples of neighboring blocks. As shown in FIG. 5, for a block of width W and height H, reference samples may be constituted from 2×H reconstructed samples to the left of the block, the top left reconstructed sample, and 2×W reference samples above the block. Unavailable reference samples may be generated by padding (e.g., a padding mechanism).

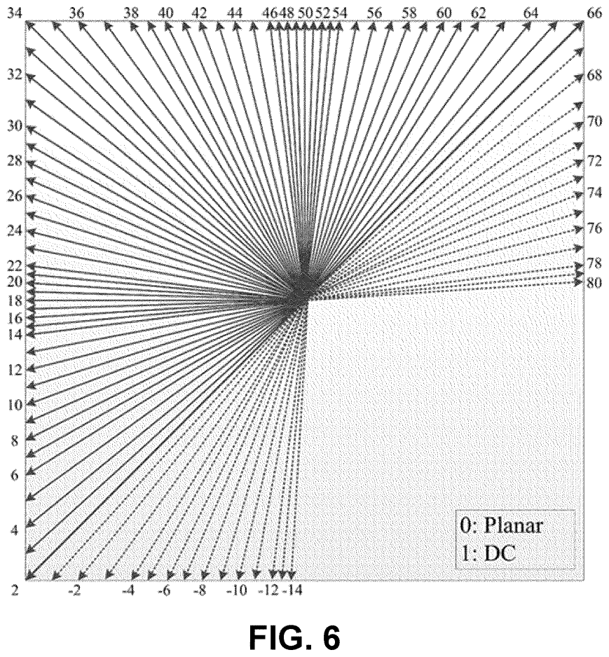

Intra mode coding may be performed, for example, with 67 intra prediction modes. FIG. 6 illustrates an example of intra prediction modes. Arbitrary edge directions presented in natural video may be captured, for example, using a number of intra prediction modes. For example, 33 directional intra modes may be used. For example, the number of directional intra modes may be 65, e.g., as depicted in FIG. 6. The same number of PLANAR and DC modes may be used (e.g., across video codecs). Dense directional intra prediction modes may be applied for (e.g., all) block sizes and/or for both luma and chroma intra predictions.

In examples, e.g., for a square CU, angular intra prediction modes 2-66 may be used, e.g., as shown in FIG. 6. Prediction modes 2-66 may correspond to angular intra prediction directions that are defined from 45 degrees to −135 degrees in a clockwise direction.

In examples, one or more (e.g., several) angular intra prediction modes may be adaptively replaced with wide angular intra prediction modes (e.g., for intra prediction for non-square blocks). As dotted arrows shown in FIG. 6, wide angular modes beyond the bottom-left direction modes may be indexed from −14 to −1. Wide angular modes beyond the top-right direction may be indexed from 67 to 80. Wide angular modes may replace a number (e.g., an equal number) of angular modes in the opposite direction, for example, for intra prediction for one or more (e.g., some) flat blocks (W>H) and/or tall blocks (W<H).

Matrix weighted Intra Prediction (MIP) may be performed. MIP may predict the samples of a rectangular block of width W and height H, for example, by taking input from one line of H reconstructed neighboring boundary samples left of the block and one line of W reconstructed neighboring boundary samples above the block. Unavailable reconstructed samples may be generated by intra prediction.

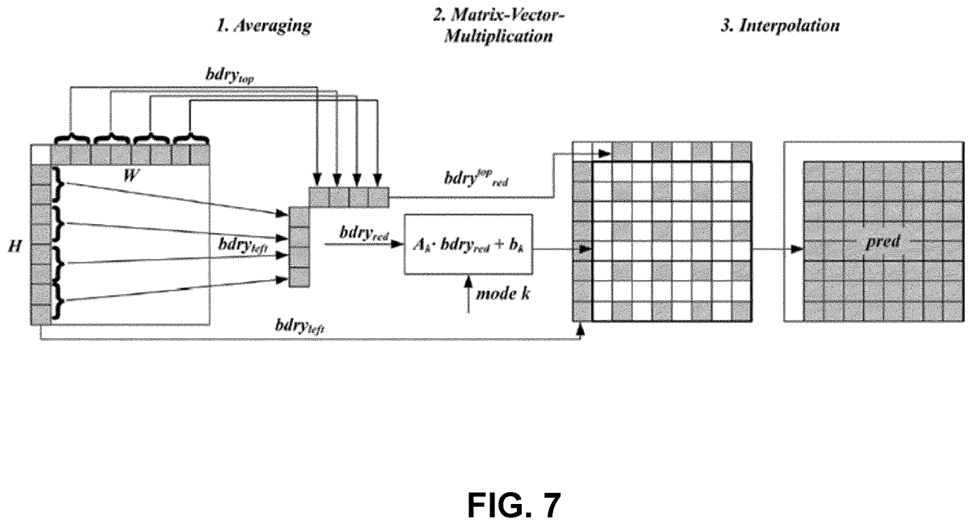

FIG. 7 illustrates an example of generating an intra prediction signal with MIP. As shown in FIG. 7, generation of a prediction signal may be based on one or more of the following steps: averaging, matrix vector multiplication, or linear interpolation. An intra prediction signal may indicate whether an MIP mode is applicable. For example, an indication (e.g., mip_flag) may be signaled (e.g., for an intra-coded block) to indicate whether an MIP mode is to be applied or not.

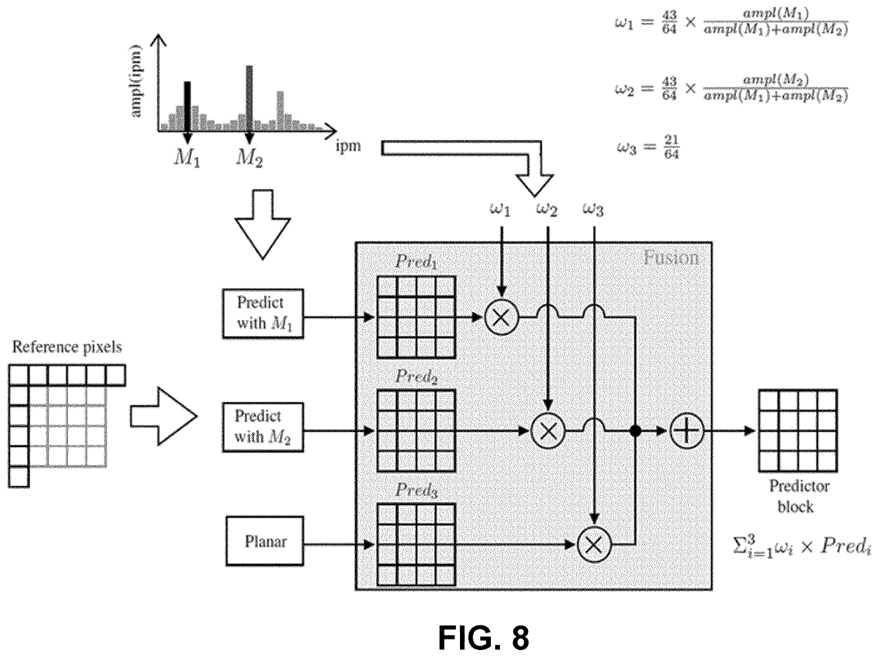

FIG. 8 illustrates an example of generating intra mode predictors for a predictor block with decoder side intra mode derivation (DIMD). As shown in FIG. 8, DIMD may be used to derive an intra mode used to code a CU. DIMD may derive intra prediction modes (e.g., IPM_{dimd_1st} and IPM_{dimd_2nd}) that are likely the (e.g., two) best intra prediction modes for predicting the current CU, for example, from a Histogram of Oriented Gradients (HOG) computed from the neighboring pixels of the current block. DIMD predictors may be combined with a planar mode predictor, e.g., with weights derived from the HOG, in a template, e.g., as illustrated in FIG. 8.

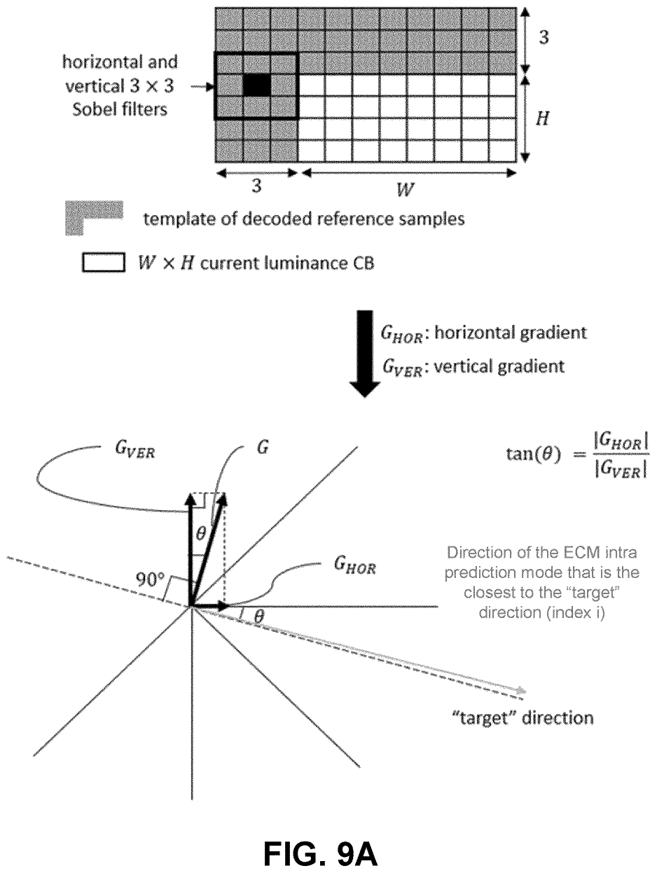

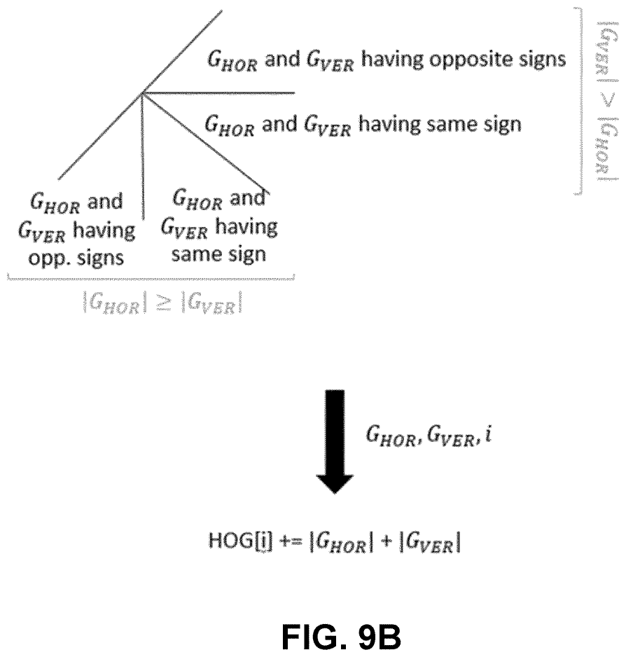

FIGS. 9A and 9B illustrate an example of deriving DIMD prediction modes from HOG bins. As shown in FIGS. 9A and 9B, DIMD intra prediction modes may be derived from the gradients in a template for a current CU. A HOG with 65 bins (e.g., corresponding to 65 directional intra prediction modes) may be initialized to zero (0). A procedure may be implemented for a decoded reference sample in the middle row or the middle column of the template of three rows of decoded reference samples above the current CU and three columns of decoded reference samples on its left side.

As shown by example in FIGS. 9A and 9B, the procedure may be performed using a 3×3 horizontal Sobel filter and a 3×3 vertical Sobel filter. The filters may be centered at a decoded reference sample. The filters may yield a horizontal gradient G_{HOR} and a vertical gradient G_{VER}, respectively. The signs of G_{HOR} and G_{VER} may indicate in which of the four ranges of directions is found the “target” direction. The target direction may be perpendicular to the gradient G of horizontal component G_{HOR} and vertical component G_{VER}. The anchor direction may correspond to the horizontal direction, for example, if |G_{VER}|>|G_{HOR}|. The anchor direction may correspond to the vertical direction, for example, if |G_{HOR}|≥|G_{VER}|. The target direction may form an angle θ with respect to the anchor direction, for example. The index i of the intra prediction mode (e.g., whose direction may be the closest to the target direction) may be found, for example, by discretizing a scaled version of tanθ). The HOG bin of index i may be incremented by |G_{HOR}|+|GVERI. The indices of the (e.g., two) largest HOG bins may be the indices of the (e.g., two) derived intra prediction modes (e.g., IPM_{dimd_1st} and IPM_{dimd_2nd}). An indication (e.g., dimd_flag) may be signaled (e.g., for an intra-coded block), for example, to indicate whether a DIMD mode is to be applied or not.

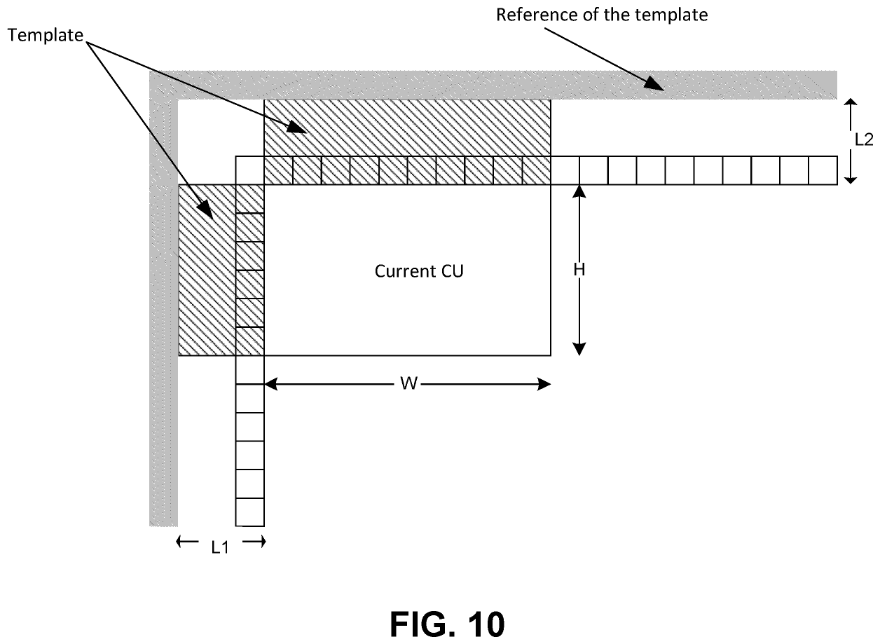

The intra mode used to code a CU may be derived, for example, using a fusion for Template-based Intra Mode Derivation (TIMD). FIG. 10 illustrates an example of TIMD. As shown in FIG. 10, the Sum of Absolute Transformed Differences (SATD) between the prediction and reconstruction samples of the template may be calculated for an intra prediction mode in the most probable modes (MPMs) list. The current CU size may be W×H. The template (e.g., as shown by a diagonal pattern in FIG. 10) may include left already reconstructed samples of size L1×H and above already reconstructed samples of size W×L2. The prediction of the template may be obtained (e.g., for an intra prediction mode) from the reference samples located in the reference of the template (e.g., gray shaded portion shown in FIG. 10). The first two intra prediction modes with the minimum SATD may be selected. The two intra prediction modes may be retained from the first pass of tests involving the MPM list supplemented with default modes. TIMD may test (e.g., in terms of prediction SATD) the two closest extended directional intra prediction modes for the two (e.g., any of the two) retained modes, for example, if the intra prediction mode is neither planar nor DC. The set of directional intra prediction modes for TIMD may be, for example, 129 (e.g., rather than 65), which may be visualized by inserting a direction between a black solid arrow in FIG. 6. The set of possible intra prediction modes derived via TIMD may, for example, gather 131 modes. The final two predictors using the selected intra prediction modes (e.g., TIMD₁ₛₜ and TIMD_{2nd}) may be fused with the weights, for example, on a condition that SATD_{IPM_timd_2nd}<2*SATD_{IPM_timd_1st} is true. Weights may depend on the SATDs of the two intra prediction modes (e.g., IPM_{timd_1st} and IPM_{timd_2nd}). The first (e.g., only the first) intra prediction mode (e.g., IPM_{timd_1st}) may be used, for example, if otherwise (e.g., on a condition that SATD_{IPM_timd_2nd}<2*SATD_{IPM_timd_1st} is false).

An indication (e.g., timd_flag) may be signaled (e.g., for an intra-coded block), for example, to indicate whether a TIMD mode is to be applied or not.

A spatial geometric partitioning mode (SGPM) may be used for intra-coding. SGPM may partition a coding block into multiple (e.g., two) parts. SPGM may generate multiple (e.g., two) corresponding intra-prediction modes.

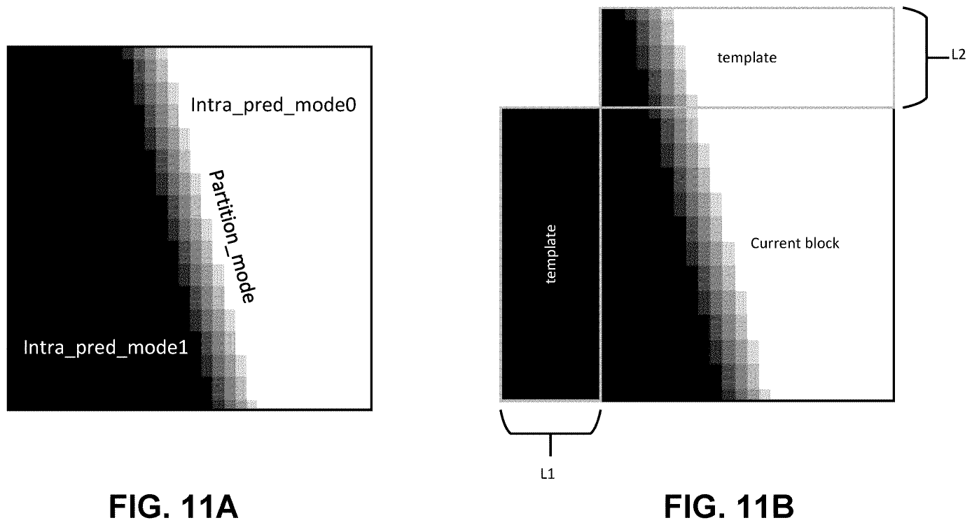

FIGS. 11A and 11B illustrate an example of SPGM. FIG. 11A shows an example of an SGPM block partitioned (e.g., according to a partition mode) into multiple (e.g., two) parts, where a part may be associated with an intra prediction mode. In examples, 26 predefined partition modes may be used. An intra prediction mode (IPM) list may be derived for a part (e.g., for a partition mode). The IPM list size may be, for example, three (3). A possible combination of one partition mode and two intra prediction modes of the IPM list may be considered as an SGPM candidate. The candidate index that is effectively used for coding may be signaled in the bit-stream.

As shown in FIG. 11B, a template may be used to generate a candidate list. The shape of the template may be the same as TIMD, which may include left already reconstructed samples of size L1×H and above already reconstructed samples of size W×L2. A prediction may be generated for the template, e.g., with the partitioning weight extended to the template, for example, for a possible combination of one partition mode and two intra prediction modes. The combinations may be ranked in ascending order of their SATD between the prediction and reconstruction of the template. The length of the candidate list may be set equal to 16. The candidates may be regarded as the most probable SGPM combinations of the current block. An encoder and decoder may construct the same candidate list based on the template.

An indication (e.g., sgpm_flag) may be signaled to indicate for an intra-coded block whether an SGPM is to be applied or not. An SPGM candidate (e.g., sgpm_cand_idx) may be signaled, e.g., on condition that sgpm_flag is true, for example, to specify which combination of one partition mode and two intra prediction modes is used, e.g., which SGPM candidate of the candidate list is used for coding.

Multiple reference line (MRL) intra prediction may use more reference lines for intra prediction. An MRL prediction mode may be useful for texture patterns with sharp and strongly directed edges. Non-adjacent reference lines may be (e.g., mainly) beneficial for texture patterns with sharp and strongly directed edges. MRL prediction mode may be less useful if texture patterns are smooth.

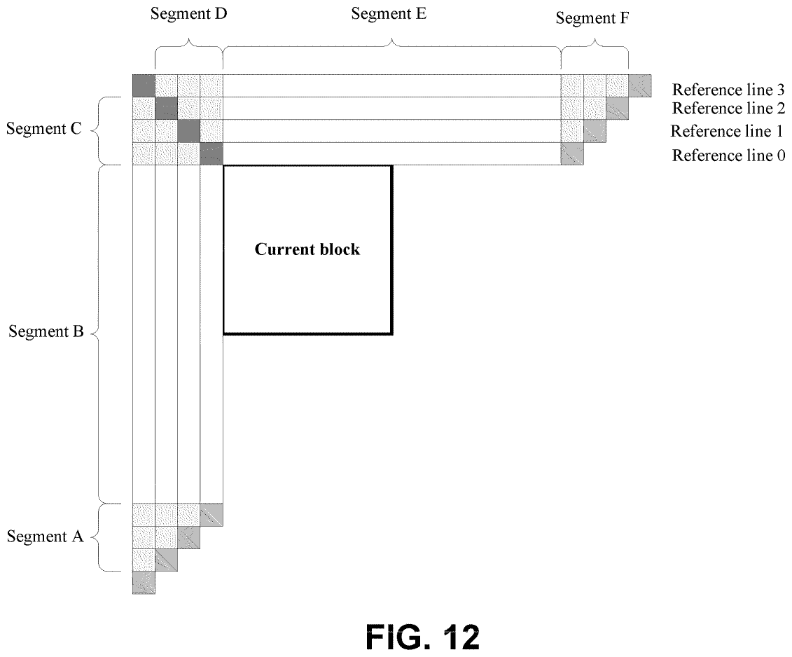

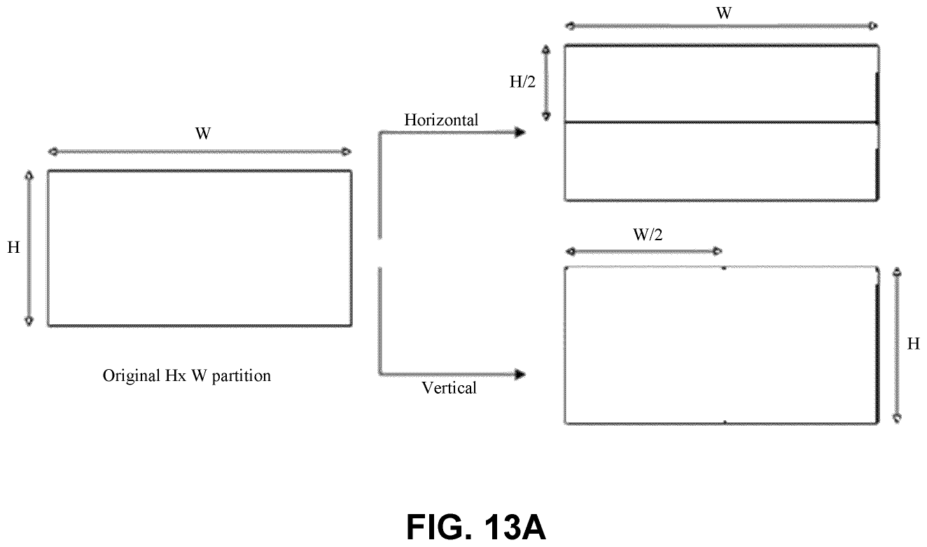

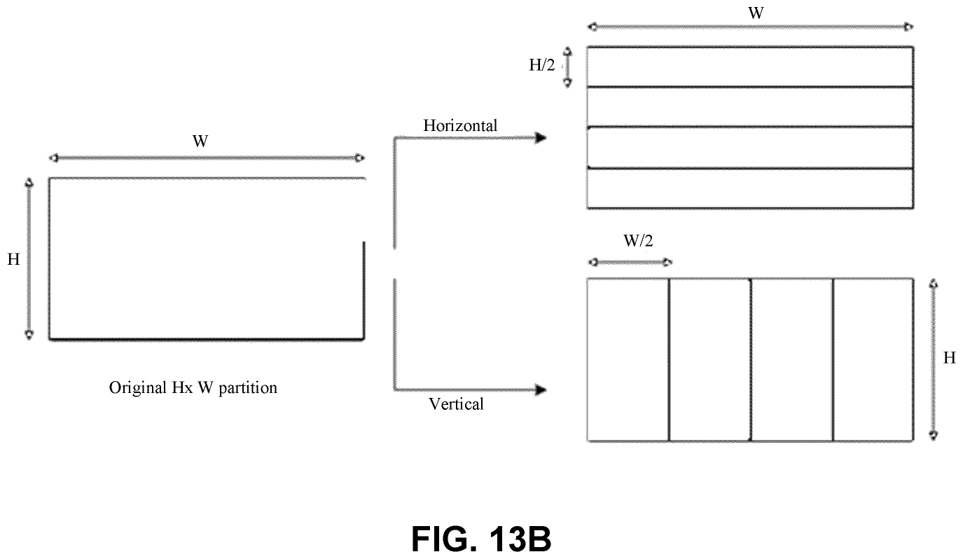

FIG. 12 illustrates an example of MRL intra prediction. In FIG. 12, an example of four (4) reference lines is provided, where the samples of segments A and F are not fetched from reconstructed neighboring samples and are, instead, padded with the closest samples from segments B and E, respectively. In examples (e.g., HEVC) intra-picture prediction may use the nearest reference line (e.g., reference line 0). In examples (e.g., in VVC), MRL intra prediction may use two (2) additional lines (e.g., reference line 1 and reference line 2). An index of selected reference line(s) (e.g., mrl_idx) may be signaled and used, for example, to generate an intra predictor. Intra sub-partitions (ISP) may be used to divide luma intra-predicted blocks vertically or horizontally into two (2) sub-partitions (e.g., in FIG. 13A) or four (4) sub-partitions (e.g., in FIG. 13B). The division may be performed based on the block size.

FIGS. 13A and 13B illustrate examples of ISPs. FIGS. 13A and 13B illustrate examples of various (e.g., two) subdivision possibilities. The reconstructed sample values of a sub-partition may be available to generate the prediction of the next sub-partition. A sub-partition may be processed subsequently. Sub-partitions (e.g., all sub-partitions) may fulfill a condition (e.g., of having at least 16 samples). Sub-partitions (e.g., all sub-partitions) may share the same intra mode. In an example of ISP mode, all (e.g., 67) intra modes may be allowed.

An indication (e.g., isp_flag) may be signaled, for example, to indicate whether an ISP is to be applied or not for an intra-coded block. An ISP mode indication (e.g., isp_mode) may be signaled, for example, to specify the split vertically or horizontally, for example, on a condition that isp_flag is true.

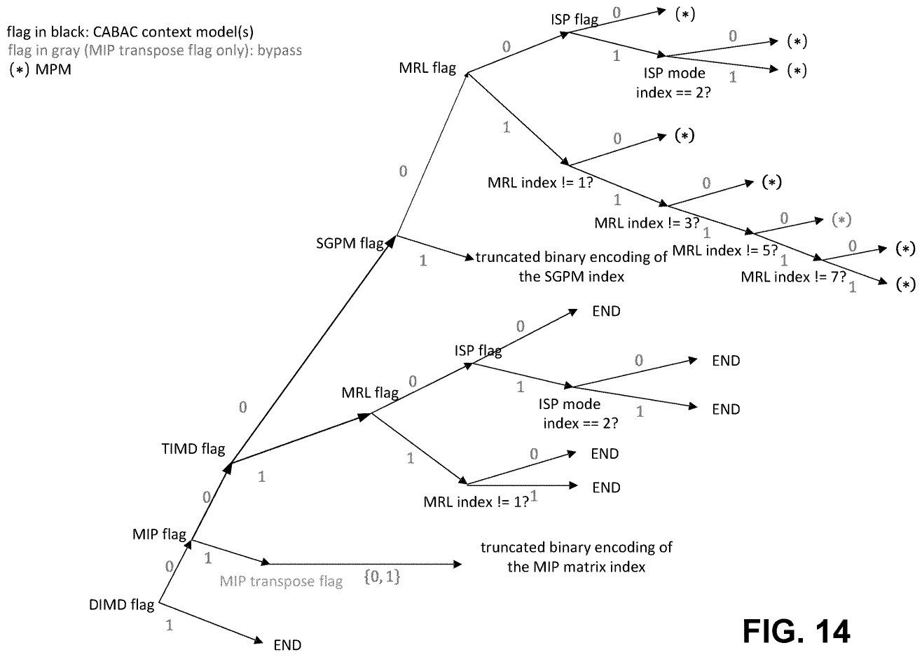

Intra prediction mode may be signaled. FIG. 14 illustrates an example of signaling an intra prediction mode selected to predict the luma component of a current CU. FIG. 14 shows examples of syntax elements associated with DIMD, MIP, TIMD, SGPM, MRL, ISP and other intra prediction modes (e.g., PLANAR, DC and angular intra prediction modes). FIG. 14 describes signaling of the intra prediction mode selected to predict the current CU on the encoder side. The same signaling shown in FIG. 14 may be applied on the decoder side. The example in FIG. 14 does not show BDPCM, Template-based Intra Prediction (TMP), Intra Block Copy (IBC), and Palette, for example, because they are activated for specific video sequences, e.g., screen content.

As shown in FIG. 14, an indication indicating whether DIMD mode is applied (e.g., dimd_flag) may be signaled (e.g., first). An indication indicating whether MIP mode may be applied (e.g., mip_flag) may be signaled (e.g., next), for example, if DIMD is signaled as not being applied. For the coding of MIP modes may signal multiple (e.g., two) separate syntax elements (e.g., indications). An indication (e.g., mip_transpose_flag) may be signaled that determines whether the transposed MIP mode is to be used or not. An index (e.g., mip_mode) may be signaled to specify which MIP mode is to be applied. The index (e.g., mip_mode) may be signaled, for example, using a truncated binary code. An indication indicating whether TIMD mode is applied (e.g., timd_flag) may be signaled (e.g., subsequently), for example, if MIP is not applied. An indication indicating whether SGPM mode is applied (e.g., sgpm_flag) may be signaled, for example, if TIMD is not applied. An index (e.g., sgpm_cand_idx) may be signaled to specify which combination of one partition mode and two intra prediction modes is used. An index (e.g., mrl_index) may be signaled to indicate which reference line is to be used, for example, if MIP and SGPM are signaled as not being applied. An indication (e.g., isp_flag) may be signaled to indicate whether ISP is applied, for example, if the adjacent reference line is applied (e.g., if mrl_index is 0). A syntax element (e.g., isp_mode) may be signaled to indicate whether horizontal or vertical splitting is applied for ISP mode, for example, if/when isp_flag is signaled as true.

Intra prediction modes enabled for the chroma components may include, for example, planar, horizontal and vertical modes (e.g., HOR_IDX, VER_IDX), DC, three cross component linear model (CCLM) modes (e.g., CCLM_LT, CCLM_L and CCLM_T), three multi-model linear model (MMLM) modes (e.g., MMLM_LT, MMLM_L and MMLM_T), DIMD, and direct mode (DM) from collocated luma block.

A most probable mode (MPM) list may be implemented. An MPM list-based signaling scheme may be used to efficiently code a mode (e.g., an optimal mode) with less signaling overhead, for example, if the intra prediction mode selected to predict the current CU is not DIMD, an MIP mode, a TIMD, or SGPM (e.g., if the intra prediction mode is an intra prediction mode).

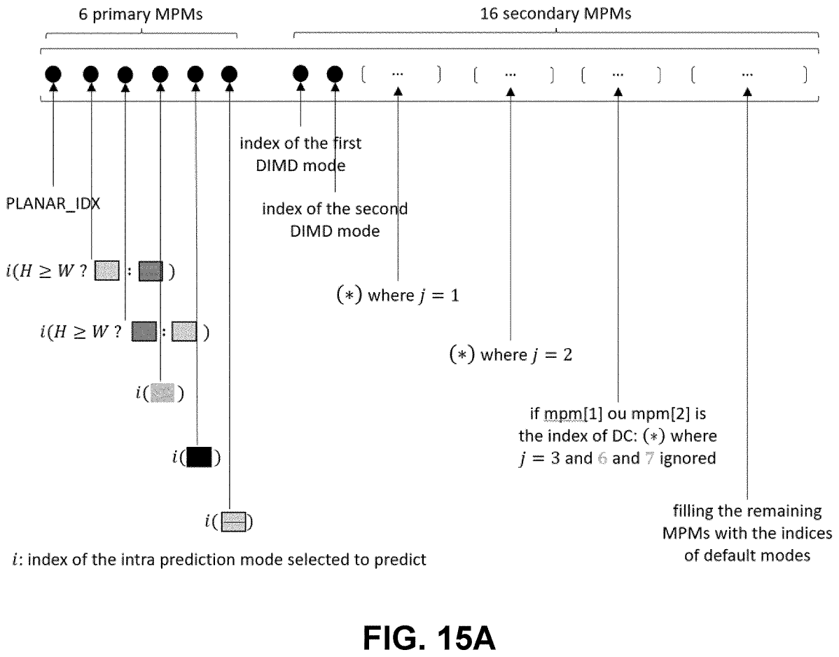

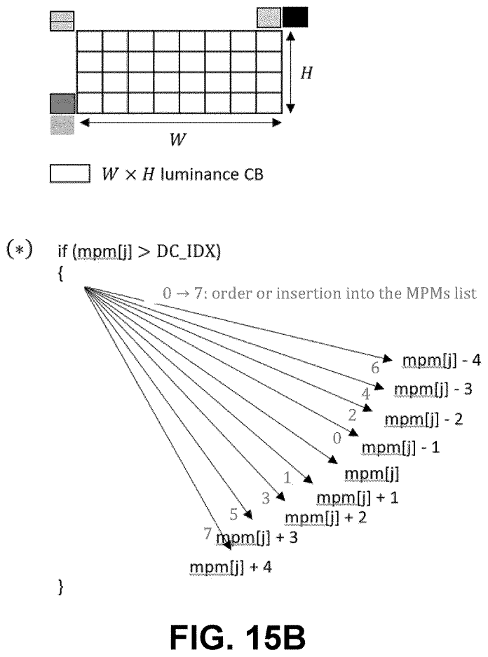

FIGS. 15A and 15B illustrate an example of an MPM list. An MPM list may include (e.g., be decomposed into) a list of (e.g., six (6) primary MPMs (PMPM) and a list of (e.g., 16) secondary MPMs (SMPM). An MPM list may be built, for example, by (e.g., sequentially) adding candidate intra prediction mode indices from the one most likely being the selected intra prediction mode for predicting the current CU to the least likely one, e.g., as depicted in FIGS. 15A and 15B.

The first entry may be the Planar mode, as depicted in FIGS. 15A and 15B. The Planar mode may be added to (e.g., inserted into) the list of MPMs. In examples, Planar mode may not be added. An MRL may not provide coding gain if/when the intra prediction mode is the Planar mode, for example, since the planar mode may be used for smooth areas. The Planar mode may be excluded as an (e.g., the first) MPM entry and/or the entries filled in SMPM may not be used, for example, if mrl_index is not 0.

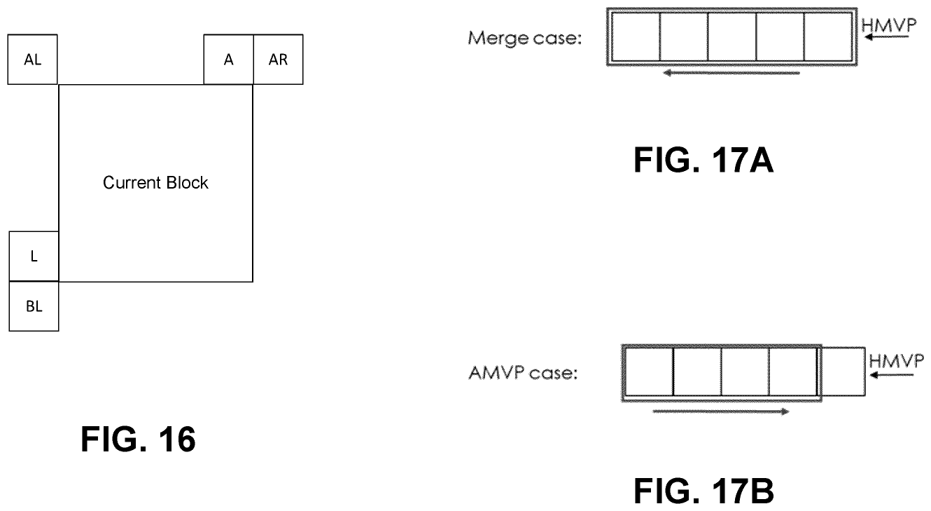

As shown in FIGS. 15A and 15B, the remaining entries may be obtained, for example, from the intra modes of the above (A), left (L), bottom-left (BL), above-right (AR), and above-left (AL) neighboring blocks, e.g., in sequential order. FIG. 16 illustrates an example of neighboring blocks relative to a current block. The neighboring blocks may be adjacent to the current block. The locations of neighboring blocks may be shown by example in FIG. 16. The order to insert intra modes of neighboring blocks into an MPM list may start from the above neighbor intra mode. The order to insert above and left neighboring intra modes may be swapped, for example, if a rectangular block is horizontal oriented, e.g., when width is greater than height.

One or more (e.g., two) directional modes generated by DIMD (e.g., IPM_{dimd_1st} and/or IPM_{dimd_2nd}) may be inserted to an MPM list, for example, if there are one or more (e.g., some) empty entries after adding spatial neighboring intra prediction modes candidates. Directional modes with an added offset (e.g., ±1, ±2, +3, +4) from the first two available directional modes of neighboring blocks (e.g., referred to as “derived modes” for simplification) and/or one or more predefined default modes may (e.g., also) be included in an MPM list. A default mode list may be defined as {DC_IDX, VER_IDX, HOR_IDX, VER_IDX-4, VER_IDX +4, 14, 22, 42, 58, 10, 26, 38, 62, 6, 30, 34, 66, 2, 48, 52, 16}. In examples, DC_IDX=1, VER_IDX=50, and/or HOR_IDX=18.

Redundancy check may be performed for a list of MPMs (e.g., such that a list of MPMs may not include two identical intra prediction mode indices). For example, the slots of indices 0 to i−1 in an MPM list may have already been filled. A candidate intra prediction mode may be skipped, for example, if the current candidate intra prediction mode index already exists in the current generic list of MPMs. The next candidate intra prediction mode may be inserted at the slot of index i, for example, if the next candidate intra prediction mode does not exist in the generic list of MPMs. The current intra prediction mode index may (e.g., otherwise) be inserted at the slot of index i and the next candidate intra prediction mode may be inserted at the slot of index i+1, e.g., if it does not exist in the generic list of MPMs.

History based motion vector prediction (HMVP) may be performed. HMVP merge candidates may be added to a merge list, for example, after the spatial MVP and TMVP. The motion information of a previously coded block may be stored in a table and used as an MVP for the current CU. A table with multiple HMVP candidates may be maintained during the encoding/decoding process. The table may be reset (e.g., emptied), for example, if/when a new CTU row is encountered. Associated motion information may be added to the last entry of the table as a new HMVP candidate, for example, if/when there is a non-subblock inter-coded CU.

An HMVP table size S may be set (e.g., to 6) to indicate how many (e.g., up to 6) HMVP candidates may be added to the table. A constrained first-in-first-out (FIFO) rule may be utilized, for example, if/when inserting a new motion candidate into the table. A redundancy check may (e.g., first) be applied to determine whether there is an identical HMVP in the table. An identical HMVP (e.g., if found) may be removed from the table, the (e.g., following) HMVP candidates may be moved forward, and the identical HMVP may be inserted as the last entry of the table.

HMVP candidates may be used in a merge candidate list construction process. The latest (e.g., several) HMVP candidates in the table may be checked in order and inserted to the candidate list after the TMVP candidate, e.g., as shown by example in FIG. 17A. A redundancy check may be applied on the HMVP candidates to the spatial or temporal merge candidate.

FIG. 17A illustrates an example of merge candidate list construction with HMVP candidates. The number of redundancy check operations may be reduced, for example, by performing a redundancy check on the last two entries in the table to above (A) and left (L), spatial candidates, respectively (e.g., as shown in FIG. 16).

The number of redundancy check operations may be reduced, for example, by terminating the merge candidate list construction process from HMVP if/when the total number of available merge candidates reaches the maximally allowed merge candidates minus 1.

HMVP candidates may be used in an AMVP candidate list construction process. The first several HMVP candidates in the table may be checked in order and inserted into the candidate list after the TMVP candidate, e.g., as shown in FIG. 17B. FIG. 17B illustrates an example of AMVP candidate list construction with HMVP candidates.

Intra prediction may be used as a fundamental coding tool in hybrid video coding. Spatial redundancy removal may support successful intra coding. An increased number of intra prediction modes may modify compression efficiency. Intra prediction modes may be deployed based on an assumption that there may exist correlations between the current block and its adjacent/nearest neighboring blocks. There may be correlations between non-adjacent similar blocks and the current block.

Although the current block and its adjacent neighboring blocks may belong to the same object, e.g., with similar texture, a (e.g., one) block may be more correlated with a non-adjacent block, for example, such as object occlusion.

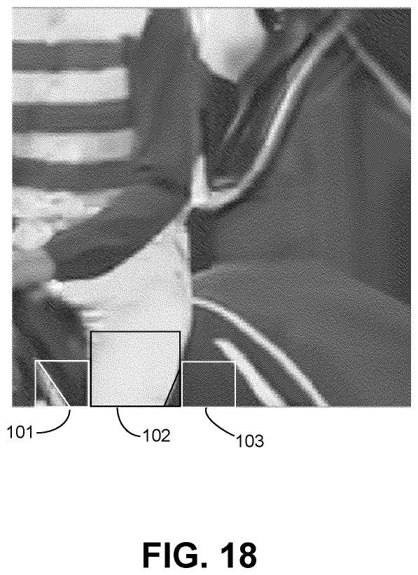

FIG. 18 illustrates an example of object occlusion. As shown by example in FIG. 18, the body of a horse shown at 101 and 103 are occluded by a rider's leg 102.

Correlation with non-adjacent blocks may be exploited, for example, by fetching intra prediction information from non-adjacent blocks. Fetching non-adjacent blocks may utilize complexity overhead in terms of memory access and line buffer sizes, e.g., for a hardware implementation. Fetching non-adjacent blocks may be addressed, for example, by creating/using a (e.g., a limited) buffer to store previously coded intra prediction information (e.g., including non-adjacent block information).

HMVP may apply to inter-coded blocks, which may add non-local motion information of a previously coded block in a limited table used for the current block. However, HMVP may be applied for intra-coded blocks.

A history-based intra prediction mode (HIPM) may be implemented. An intra prediction mode of previous intra-coded (e.g., intra-predicted) neighboring blocks, which may be separated by a block from a current block (e.g., non-adjacent to the current block, not immediately adjacent to the current block, etc.), may be treated as HIPM candidates. One or more (e.g., multiple) HIPM candidates may be stored in an HIPM table (e.g., the HIPM table may include multiple HIPM candidates). The HIPM table may be maintained during the encoding/decoding process (e.g., on-the-fly). HIPM candidate(s) (e.g., an intra prediction mode of an intra-predicted neighboring block) may be utilized in an MPM list construction process and/or may be utilized as a luma/chroma intra mode to code a block. For example, an MPM list associated with the current block may be obtained based on the HIPM table. The current block may be processed (e.g., encoded and/or decoded) based on the MPM list. Fusion for HIPM candidates may be utilized as a luma/chroma intra mode to code a block.

Correlations between a current block and its non-adjacent similar blocks may be utilized for improving an intra prediction. HIPM is described herein, including the principle of how HIPM works, the process of how to construct HIPM candidates in an HIPM table, how to utilize the HIPM in an intra prediction candidate construction process (e.g., including as an MPM candidate and/or as a luma/chroma intra mode), and fusion for HIPM candidates may be performed.

A current block and its adjacent neighboring blocks may have correlations. A block may be more correlated with a non-adjacent block, for example, in object occlusion.

HIPM may explore correlations between the current block and its non-adjacent similar blocks. An intra prediction mode of intra-coded blocks, which may be separated from the current block by at least a block (e.g., non-adjacent to the current block, distant from the current block, far away from the current block, etc.), may be treated as HIPM candidates. For the current block, an intra-predicted neighboring block may be identified (e.g., by a video encoder and/or decoder) that is separated from the current block by a block. An intra prediction mode of the intra-predicted neighboring block may be determined. The current block may be processed (e.g., encoded and/or decoded) based on the intra prediction mode of the intra-predicted neighboring block. Multiple HIPM candidates may be stored in a table (e.g., in a limited number), which may be referred to as the HIPM table. The table may be maintained during the encoding/decoding process (e.g., on-the-fly).

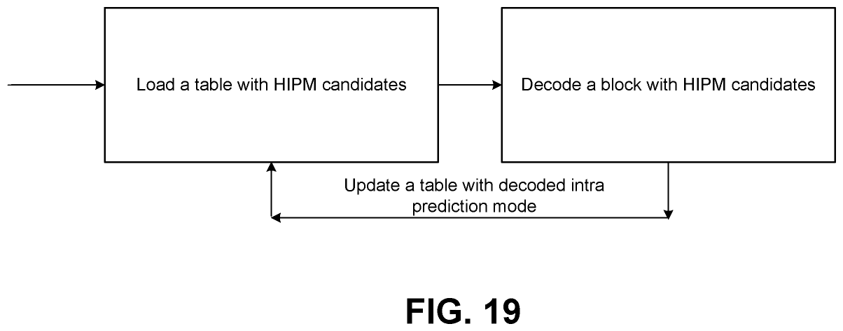

An HIPM table may be reset (e.g., emptied), for example, if/when starting coding/decoding a new CTU. Associated intra prediction mode(s) may be added to a designated entry (e.g., a last entry) of the table as a new HIPM candidate, for example, if/when there is an intra-coded block (e.g., not MIP/CCLM/MMLM). An example of the overall coding flow is depicted in FIG. 19.

FIG. 19 illustrates an example of HIPM coding. An HIPM table size may be set to a (e.g., predefined) value S, which may indicate up to S HIPM candidates may be added to the table. There may be more than S HIPM candidates from the previously coded blocks. A FIFO rule may be applied so that the table includes the latest S intra prediction mode candidates previously coded.

The HIPM table may include multiple HIPM candidates. A redundancy check may be conducted (e.g., first) to determine (e.g., find) whether there is an identical HIPM in the HIPM table (e.g., whether the intra prediction mode of the intra-predicted neighboring block is identical to an HIPM candidate in the HIPM table), for example, if/when appending an HIPM to the table. An identical HIPM candidate may be removed from the table based on a determination that the intra prediction mode of the intra-predicted neighboring block is identical to an HIPM candidate in the HIPM table. HIPM candidates following/behind a removed identical HIPM may be moved forward with indices reduced by 1 (e.g., the HIPM candidates in the HIPM table that were behind the identical HIPM candidate before removing the identical HIPM candidate may be moved). An identical HIPM may be inserted to the last entry of the table. The first HIPM candidate in the HIPM table may be removed and HIPM candidates in the HIPM table may be moved forward, for example, if a redundancy is not found (e.g., if it is determined that the intra prediction mode of the intra-predicted neighboring block is not identical/is distinguishable from the HIPM candidates in the HIPM table) and the HIPM table size is S. An HIPM candidate (e.g., the intra prediction mode of the intra-predicted neighboring block) may be appended to a designated entry in the table (e.g., the end of the table).

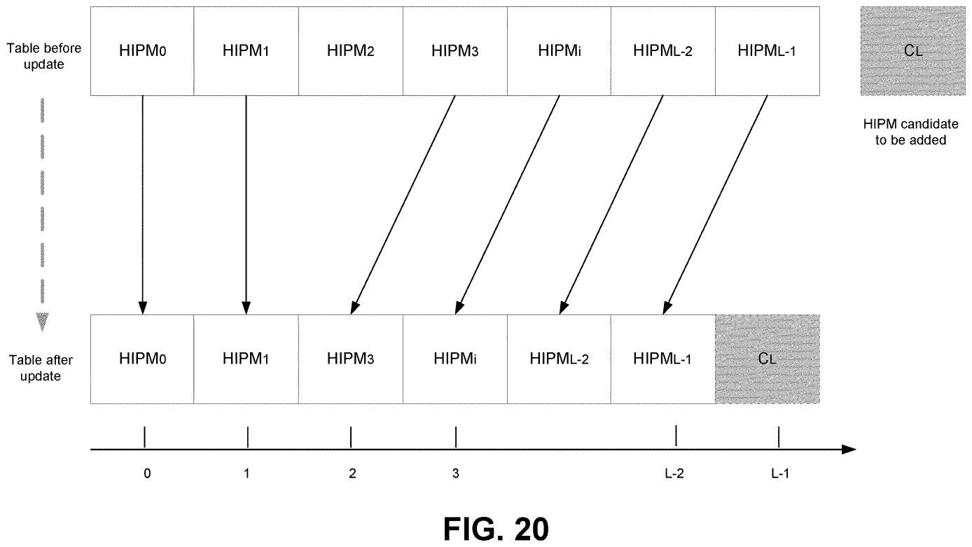

FIG. 20 illustrates an example of HIPM table maintenance. FIG. 20 depicts an example application of a FIFO rule to remove an HIPM candidate and add a new HIPM candidate to a table. For example, there may be L HIPM candidates in the table denoted by HIPMi, where i may denote the HIPM candidate index and i may be within the range of [0, L−1], e.g., as shown in FIG. 20. A new HIPM candidate denoted as C_{L} to be added may (e.g., may first) be compared to existing HIPM candidates in the HIPM table. HIPM candidates with indices larger than two (2) may be moved forward toward the head of the table, for example, if C_{L} is identical to HIPM 2. C_{L} may be put at the end of the HIPM table.

In examples, an HIPM table may be constructed based on the appearance of the existing HIPM in the table. A redundancy check may be conducted (e.g., first, when appending a new HIPM to the table) to determine whether there is an identical HIPM in the HIPM table. Based on the determination that the intra prediction mode of the intra-predicted neighboring block is identical to an existing HIPM candidate in the HIPM table, the count of the identical HIPM candidate (e.g., if found) may be increased (e.g., accumulated) (e.g., the significance of the identical HIPM candidate may be increased). The current HIPM table may be reordered based on the appearance counts of the candidate(s). For example, an HIPM candidate (e.g., an HIPM candidate with an appearance count higher than the last entry of the current HIPM table) may be placed/moved to the last entry of the table, which may indicate that the HIPM candidate in the last entry of the table is considered to be most popular (e.g., most significant). The HIPM table may be reordered (e.g., the first HIPM candidate may be removed and HIPM candidates in the HIPM table with the same appearance count as the new HIPM candidate may be moved forward), for example, if a redundancy is not found (e.g., based on a determination that the intra prediction mode of the intra-predicted neighboring block is distinguishable from the HIPM candidates in the HIPM table) and the HIPM table size is S. A new HIPM candidate may be appended before other candidates with higher appearances in the table (e.g., the HIPM table may be reordered).

In examples, more than one intra prediction mode may be available from a (e.g., one) previously intra-coded block. The multiple available intra modes may be inserted into the HIPM table. A (e.g., one) previously intra coded block may use SGPM, which may indicate that multiple (e.g., two) intra prediction modes from the SGPM block may be available. The multiple (e.g., two) intra prediction modes may be appended as new HIPM candidates. Multiple (e.g., the first two) HIPM candidates may be removed (e.g., rather than one), and (e.g., all) HIPM candidates in the HIPM table may be moved forward, e.g., with indices reduced accordingly (e.g., by two (2)), for example, if no redundancy is found and the HIPM table size is S.

In examples, an HIPM table may be reset (e.g., emptied), for example, if/when starting coding/decoding a new tile/slice/subpicture/frame/or a (e.g., one) predefined region (e.g., 512×512, 1024×1024).

In examples, the value of an HIPM table size S may be (pre)defined (e.g., as fixed for (all) sequences) or may be signaled, for example, in a view parameter set (VPS), a sequence parameter set (SPS), a picture parameter set (PPS), an adaptation parameter set (APS), a picture header (PH), etc.

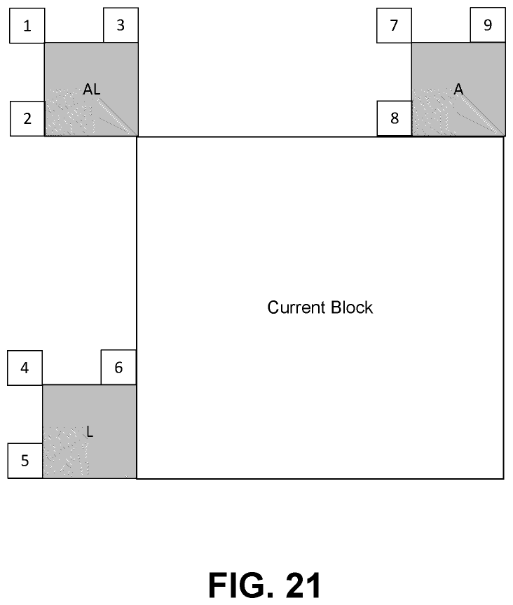

As described herein, an intra prediction mode of the available spatial neighboring blocks of current block's spatial neighboring blocks may be treated as an HIPM candidate. For example, an intra prediction mode of neighboring blocks located above (A), to the left (L), and above-left (AL) of the A, L and AL neighboring blocks of a current block may be appended (e.g., in sequential order) in an HIPM table, as shown by example in FIG. 21.

FIG. 21 illustrates an example of an order of entries in an HIPM table. An HIPM table may be reset (e.g., emptied), for example, if/when (e.g., starting) coding/decoding a new CU. An associated intra prediction mode may be added as an entry of the table as a new HIPM candidate, for example, if/when the available spatial neighboring block is an intra-coded block. The constructing order of the HIPM table may be, for example, as indicated by the numbers 1-9 shown in FIG. 21: 1. the neighboring block to the above-left of AL neighboring block of current block; 2. the neighboring block to the left of AL neighboring block of current block; 3. the neighboring block to the above of AL neighboring block of current block; 4. the neighboring block to the above-left of L neighboring block of current block; 5. the neighboring block to the left of L neighboring block of current block; 6. the neighboring block to the above of L neighboring block of current block; 7. the neighboring block to the above-left of A neighboring block of current block; 8. the neighboring block to the left of A neighboring block of current block; and 9. the neighboring block to the above of A neighboring block of current block.

The order to insert intra modes of neighboring blocks into the HIPM table may be built, for example, starting from other spatial neighboring blocks, such as above neighboring intra mode. The constructing order may be adapted, for example, based on the shape of the block, such as the different orders for horizontal-oriented rectangular block (e.g., width is greater than height) and vertical-oriented rectangular block (e.g., width is smaller than height).

An HIPM table size may be set to be a predefined value S. There may be more than S HIPM candidates from the available spatial intra-coded blocks. The FIFO rule may be applied so that the table (e.g., always) includes the latest S intra prediction mode candidates previously coded. A redundancy check may be conducted (e.g., first), for example, when appending an HIPM to the table, e.g., to find whether there is an identical HIPM in the table. An identical HIPM candidate (e.g., if found) may be inserted into a designated entry (e.g., a last entry) of the table and the HIPM candidates following/behind the identical HIPM candidate may be moved forward. The first HIPM candidate may be removed and HIPM candidates in the HIPM table may be moved forward, for example, if no redundancy is found and the HIPM table size is S. The new HIPM candidate may be appended at the end of the table.

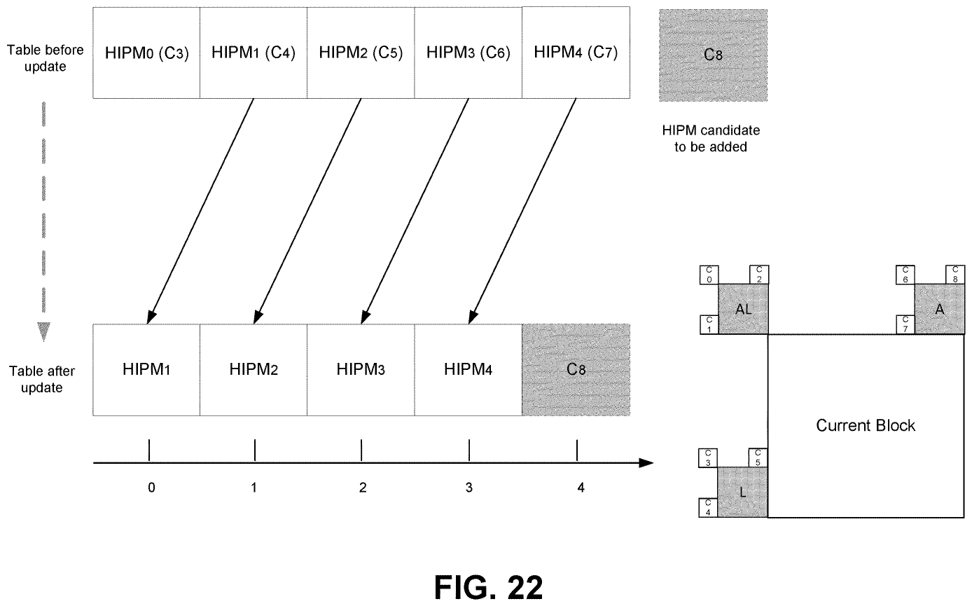

FIG. 22 illustrates an example of adding to a table with an HIPM candidate from the available spatial neighboring blocks of a current block's spatial neighboring blocks. For example, there may be nine (9) available spatial neighboring blocks denoted by Cᵢ, where i may denote the candidate index, i may be within the range of [0, 8]. The HIPM table size may be set to be 5, and there may be 5 HIPM candidates already in the table. A new HIPM candidate denoted as C₈ may be added, for example, by (e.g., first) comparing C₈ to existing HIPM candidates. If no redundancy is found, the first HIPM candidate may be removed, the following HIPM candidates may be moved (e.g., moved forward toward the head of the table), and the new candidate C₈ may be placed at a designated entry (e.g., the end) of the HIPM table.

In examples, an intra prediction mode of more, fewer, and/or other spatial neighboring blocks of a current block's spatial neighboring blocks may be treated as an HIPM candidate. For example, the spatial neighboring blocks of a current block's bottom-left (BL) and above-right (AR) neighboring blocks may be treated as an HIPM candidate.

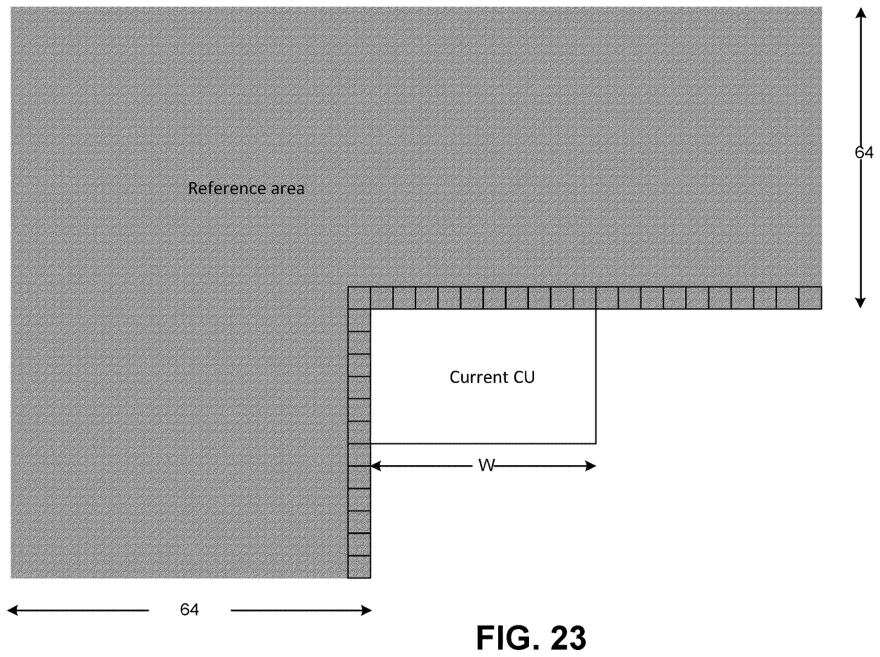

In examples, an intra prediction mode of available spatial neighboring blocks of a current block's reference region may be considered as an HIPM candidate. For example, an intra prediction mode of the neighboring blocks in a reference region (e.g., as shown by example in FIG. 23) may be appended in an HIPM table.

FIG. 23 illustrates an example of a reference region with intra prediction mode(s) that may be appended in an HIPM table. As shown in FIG. 23, a reference region may include 64 lines of samples above and to the left of the block. A reference region may, for example, extend one block width to the right and/or one block height below the block boundaries.

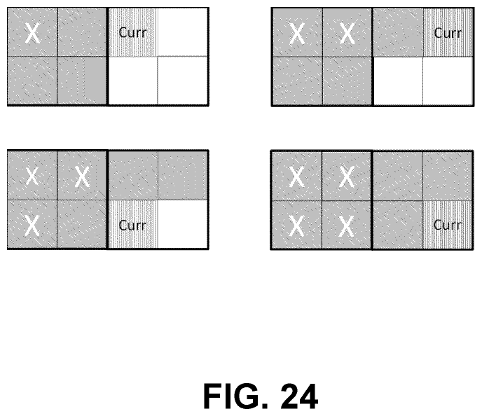

In examples, the same reference region of IBC may be applied for HIPM, e.g., as depicted by example in FIG. 24.

FIG. 24 illustrates an example of an application of a reference region of IBC for HIPM. As shown in FIG. 24, a block may represent 64×64 samples. The reference region may vary, for example, depending on the location of the current coding block location within the current CTU. In an example, the reference region may include the blocks in the bottom-right, bottom-left, and top-right 64×64 blocks of the left CTU (e.g., in addition to the already reconstructed blocks in the current CTU), for example, if the current block falls in the top-left (e.g., 64×64) block of the current CTU. In an example, the reference region may include the blocks in the bottom-right and bottom-left 64×64 blocks of the left CTU (e.g., in addition to the already reconstructed blocks in the current CTU), for example, if the current block falls into the top-right 64×64 block of the current CTU. In an example, the reference region may include the blocks in the bottom-right 64×64 block of the left CTU (e.g., in addition to the already reconstructed blocks in the current CTU), for example, if the current block falls into the bottom-left 64×64 block of the current CTU. In an example, the current block may refer to the already reconstructed blocks in the current CTU, for example, if the current block falls into the bottom-right 64×64 block of the current CTU.

In examples, the value of the HIPM table size S may be based on the block size, e.g., width and/or height of the current block. The size of the HIPM table S may be (pre)defined and/or fixed for sequences (e.g., all sequences), and/or be signaled (e.g., in VPS, SPS, PPS, APS, PH).

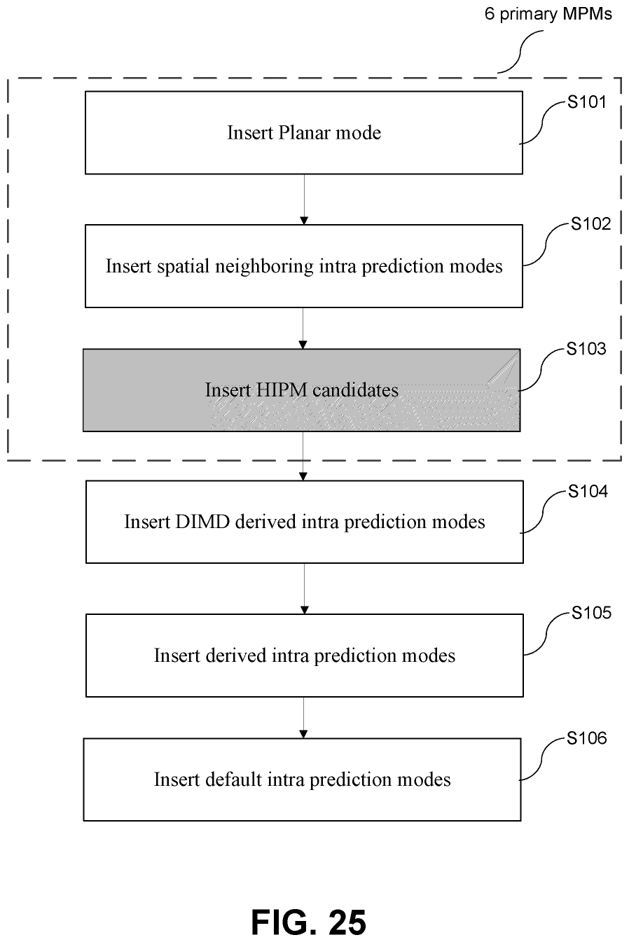

HIPM may be used in an intra prediction candidate construction process. For example, HIPM may be utilized in an MPM list construction process. FIG. 25 illustrates an example of using HIPM in an MPM list construction process. As shown in gray at S103 in FIG. 25, an MPM candidate list construction process may be modified with inserting HIPM candidates. HIPM candidates stored in the HIPM table may be utilized to fill in the PMPM list, for example, if there are one or more (e.g., some) empty entries, e.g., after adding planar mode and/or spatial neighboring intra prediction modes candidates. A (e.g., one) block may have a higher correlation with the nearest neighboring block, e.g., in terms of intra prediction mode. HIPM candidates in the table may be inserted in a descending order of indices. The last entry in the table may be added first to the list. The first entry may be added in the end. Redundancy removal may be applied on the HIPM candidates. A PMPM list construction process is terminated, for example, if/when the total number of available PMPM candidates reaches the maximal allowed number (e.g., a maximum of 6). Multiple (e.g., two) directional modes generated by DIMD may be inserted to the PMPM list, for example, if the PMPM list is still not full.

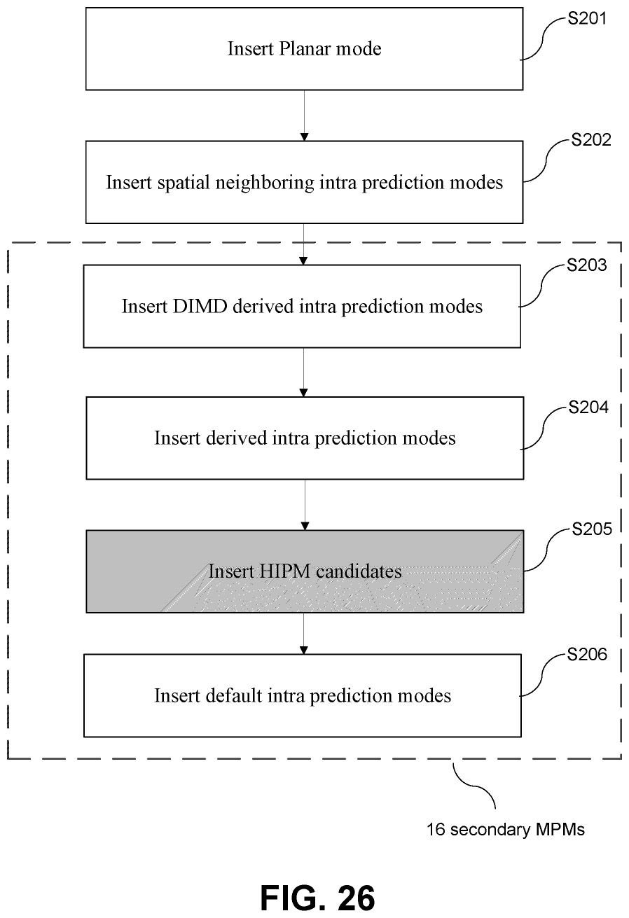

HIPM candidates stored in the HIPM table may be utilized to fill in the SMPM list. FIG. 26 illustrates an example of using HIPM candidates stored in an HIPM table to fill in an SMPM list. As shown in gray at S205 in FIG. 26, an MPM candidate list construction process may be modified with inserting HIPM candidates. There may be one or more (e.g., some) empty entries, for example, after adding derived modes candidates, but before inserting the default modes from a predefined list. HIPM candidates may be inserted into an SMPM list, e.g., until the SMPM list is fulfilled and/or (e.g., all) the candidates in the HIPM table have been unutilized. Default modes (e.g., from a predefined list) may be inserted into the SMPM list, for example, if the SMPM list is still not full.

In examples, (e.g., only) the last entry of the HIPM table may be utilized in MPM list construction. In examples, (e.g., only) the last M entries of the HIPM table may be utilized in MPM list construction.

In examples, (e.g., only) M entries of the HIPM table may be utilized in MPM list construction. A template may be used to reorder the HIPM candidates in the HIPM table. As shown in FIG. 10, the shape of the template may be the same as TIMD/SGPM, which may include left already reconstructed samples of size L1×H and above already reconstructed samples of size W×L2, respectively. The prediction of the template may be obtained for an HIPM candidate from the reference samples located in the reference of the template (e.g., gray portion shown in FIG. 10). The first M HIPM candidates with the minimum SATD may be selected.

In examples, the value of the allowed HIPM entries M for MPM list may be based on the block size, e.g., width and/or height of the current block. The allowed HIPM entries M may (e.g., alternatively) be (pre)defined and/or fixed for sequences, or may be signaled (e.g., in VPS, SPS, PPS, APS, PH).

In examples, the position to insert HIPM candidate(s) may be after the multiple (e.g., two) directional modes generated by DIMD, e.g., before the derived modes.

HIPM may be utilized as an intra mode construction process to code a block. An intra prediction mode in the last entry of the HIPM table may be used for coding a block, for example, if/when the HIPM is applied. An indication (e.g., a flag, such as hipm_flag) may be signaled (e.g., for an intra-coded block) to indicate whether an HIPM mode is to be applied or not. An encoder may perform an (e.g., additional) RDO check in the intra prediction process.

In examples, HIPM candidates stored in an HIPM table may be utilized for coding a block. A block may have a higher correlation with the nearest neighboring block, e.g., in terms of intra prediction mode. HIPM candidates in the table may be inserted in a descending order of indices. The last entry in the table may be added first to the list for coding a block. The first entry may be added in the end. An indication of HIPM candidate may be provided (e.g., for an intra-coded block, for example, on condition that the hipm_flag is true). For example, a syntax element (e.g., hipm_idx) may be signaled (e.g., by truncated unary code) to specify which HIPM candidate is selected to predict the current block.

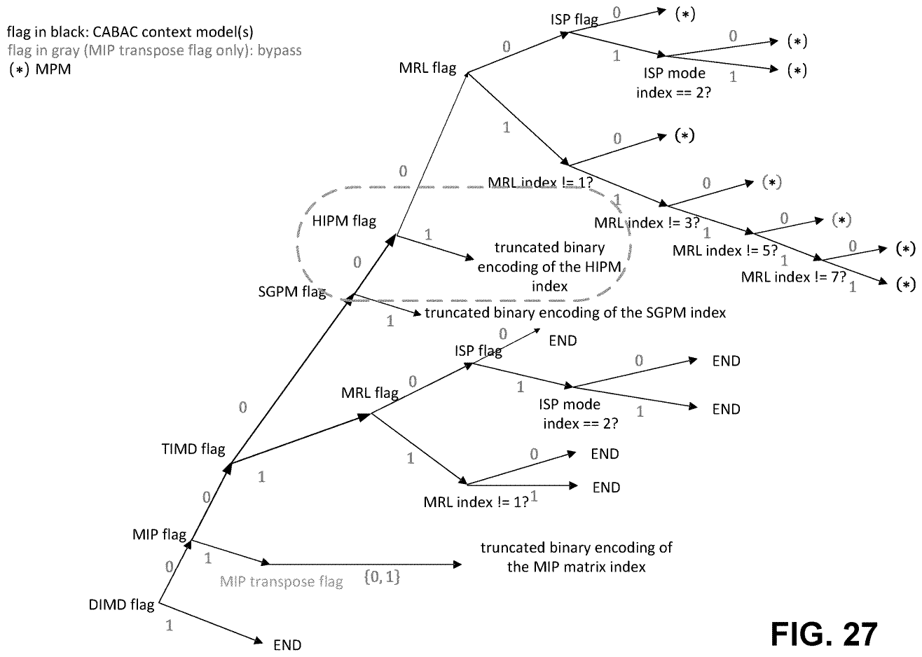

FIG. 27 illustrates an example of signaling of an intra prediction mode selected to predict the luma component of a current CU. As indicated in FIG. 27 by a dashed circle, an HIPM indication may indicate whether HIPM mode is applied. For example, an indication (e.g., hipm_flag) may be signaled to indicate whether HIPM mode is applied. As shown in the example in FIG. 27, the applicability of HIPM may be determined if/when the intra prediction mode selected to predict the current CU is none of DIMD, MIP, TIMD, or SGPM. An HIPM index (e.g., hipm_idx) may be signaled to specify which HIPM candidate is applicable (for example, if/when hipm_flag is signaled as true).

In examples, the last M entries of the HIPM table may be utilized for coding a block.

In examples, M entries of the HIPM table may be utilized for coding a block. A template may be used to reorder the HIPM candidates in the HIPM table.

In examples, the position to test/check HIPM mode may be another position, such as after DIMD mode.

In examples, HIPM may be utilized as a chroma intra mode. For example, HIPM may be tested/checked after DM for the chroma components.

Fusion for HIPM may be utilized as an intra mode construction process to code a block. The SATD between the prediction and reconstruction samples of the template may be calculated (e.g., for an HIPM candidate stored in the HIPM table), for example, if/when the fusion for HIPM is applied. The shape of the template may be the same as TIMD/SGPM, which may include, respectively, left already reconstructed samples of size L1×H and above already reconstructed samples of size W×L2. The prediction of the template may be obtained for an HIPM candidate from the reference samples located in the reference of the template (e.g., gray part shown in FIG. 10). The first M HIPM candidates with the minimum SATD may be selected. The predefined value M may be set to two (2), e.g., as indicated in the following example. the final two predictors using the selected HIPM candidates HIPM₁ₛₜ and HIPM_{2nd} may be fused with the weights, for example, on a condition that SATD_{HIPM_2nd}<2*SATD_{HIPM_1st} is true. The weights may depend on the SATDs of the (e.g., two) HIPM candidates. The first selected HIPM candidate HIPM₁ₛₜ (e.g., only the first selected HIPM candidate HIPM₁ₛₜ) may be used, for example, if otherwise (e.g., SATD_{HIPM_2nd}>2*SATD_{HIPM_1st} is true).

In examples, a fusion for HIPM may use the last M entries of the HIPM table. Their predictors of the last M entries may be averaged to obtain the final predictor.

In examples, an original HIPM mode may be reserved. An HIPM fusion mode may be signaled, for example, as a mode, e.g., by signaling an indication in the bitstream.

In examples, fusion HIPM may be utilized as a chroma intra mode.

HIPM may be implemented in (e.g., extended to) MIP mode. Examples described herein may be applied to MIP. MIP may (e.g., may not) have the concept of directionality, which may influence constructing a history table of different PU sizes. Multiple history tables may be constructed and used with the same PU size.

HIPM may affect video coding (e.g., in an encoder and decoder), distribution, and/or consumption.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-32. (canceled)

33. A video decoding device comprising:
a processor configured to:
for a current block, identify an intra-predicted neighboring block that is separated from the current block by at least a block;
determine an intra prediction mode of the intra-predicted neighboring block;
include the intra prediction mode in a history-based intra prediction mode (HIPM) table; and
decode the current block based on the HIPM table.

34. The device of claim 33, wherein the processor is further configured to:
add the intra prediction mode of the intra-predicted neighboring block to a most probable mode (MPM) list associated with the current block; and
decode the current block based on the MPM list.

35. The device of claim 33, wherein the processor is further configured to:
obtain a most probable mode (MPM) list associated with the current block based on the HIPM table; and
decode the current block based on the MPM list.

36. The device of claim 33, wherein the processor is further configured to:
determine whether the intra prediction mode of the intra-predicted neighboring block is identical to at least one HIPM candidate from a plurality of HIPM candidates in the HIPM table;
based on the determining that the intra prediction mode of the intra-predicted neighboring block is identical to at least one HIPM candidate in the HIPM table:
remove the at least one identical HIPM candidate from the HIPM table;
move each of the plurality of HIPM candidates in the HIPM table that were behind the at least one identical HIPM candidate before removing the at least one identical HIPM candidate; and
add the intra prediction mode of the intra-predicted neighboring block to a designated entry in the HIPM table.

37. The device of claim 33, wherein the processor is further configured to:
determine that the intra prediction mode of the intra-predicted neighboring block is distinguishable from a plurality of HIPM candidates in the HIPM table; and
based on the determination:
remove a first HIPM candidate from the HIPM table;
move each of the plurality of HIPM candidates in the HIPM table that were behind the first HIPM candidate before removing the first HIPM candidate; and
add the intra prediction mode of the intra-predicted neighboring block to a designated entry in the HIPM table.

38. The device of claim 33, wherein the processor is further configured to:
determine that the intra prediction mode of the intra-predicted neighboring block is identical to at least one of a plurality of HIPM candidates in the HIPM table; and
based on the determination:
increase a significance of the at least one identical HIPM candidate; and
reorder the HIPM table.

39. The device of claim 33, wherein the processor is further configured to:
determine that the intra prediction mode of the intra-predicted neighboring block is distinguishable from a plurality of HIPM candidates in the HIPM table; and
based on the determination:
remove a first HIPM candidate from the HIPM table;
add the intra prediction mode of the intra-predicted neighboring block in the HIPM table; and
reorder the HIPM table.

40. The device of claim 33, wherein the processor is further configured to:
receive an HIPM index configured to indicate a first HIPM candidate from a plurality of HIPM candidates in the HIPM table; and
decode the current block using the first HIPM candidate.

41. A method for video decoding, the method comprising:
for a current block, identifying an intra-predicted neighboring block that is separated from the current block by at least a block;
determining an intra prediction mode of the intra-predicted neighboring block;
including the intra prediction mode in a history-based intra prediction mode (HIPM) table; and
decoding the current block based on the HIPM table.

42. The method of claim 41, wherein the method further comprises:
adding the intra prediction mode of the intra-predicted neighboring block to a most probable mode (MPM) list associated with the current block; and
decoding the current block based on the MPM list.

43. The method of claim 41, wherein the method further comprises:
obtaining a most probable mode (MPM) list associated with the current block based on the HIPM table; and
decoding the current block based on the MPM list.

44. The method of claim 41, wherein the method further comprises:
determining whether the intra prediction mode of the intra-predicted neighboring block is identical to at least one HIPM candidate from a plurality of HIPM candidates in the HIPM table;
based on the determining that the intra prediction mode of the intra-predicted neighboring block is identical to at least one HIPM candidate in the HIPM table:
removing the at least one identical HIPM candidate from the HIPM table;
moving each of the plurality of HIPM candidates in the HIPM table that were behind the at least one identical HIPM candidate before removing the at least one identical HIPM candidate; and
adding the intra prediction mode of the intra-predicted neighboring block to a designated entry in the HIPM table.

45. The method of claim 41, wherein the method further comprises:
determining that the intra prediction mode of the intra-predicted neighboring block is distinguishable from a plurality of HIPM candidates in the HIPM table; and
based on the determination:
removing a first HIPM candidate from the HIPM table;
moving each of the plurality of HIPM candidates in the HIPM table that were behind the first HIPM candidate before removing the first HIPM candidate; and
adding the intra prediction mode of the intra-predicted neighboring block to a designated entry in the HIPM table.

46. The method of claim 41, wherein the method further comprises:
determining that the intra prediction mode of the intra-predicted neighboring block is identical to at least one of a plurality of HIPM candidates in the HIPM table; and
based on the determination:
increasing a significance of the at least one identical HIPM candidate; and
reordering the HIPM table.

47. The method of claim 41, wherein the method further comprises:
determining that the intra prediction mode of the intra-predicted neighboring block is distinguishable from a plurality of HIPM candidates in the HIPM table; and
based on the determination:
removing a first HIPM candidate from the HIPM table;
adding the intra prediction mode of the intra-predicted neighboring block in the HIPM table; and
reordering the HIPM table.

48. The method of claim 41, wherein the method further comprises:
receiving an HIPM index configured to indicate a first HIPM candidate from a plurality of HIPM candidates in the HIPM table; and
decoding the current block using the first HIPM candidate.

49. A video encoding device comprising:
a processor configured to:
for a current block, identify an intra-predicted neighboring block that is separated from the current block by at least a block;
determine an intra prediction mode of the intra-predicted neighboring block;
include the intra prediction mode in a history-based intra prediction mode (HIPM) table; and
encode the current block based on the HIPM table.

50. The device of claim 49, wherein the processor is further configured to:
add the intra prediction mode of the intra-predicted neighboring block to a most probable mode (MPM) list associated with the current block; and
encode the current block based on the MPM list.

51. The device of claim 49, wherein the processor is further configured to:
obtain a most probable mode (MPM) list associated with the current block based on the HIPM table; and
encode the current block based on the MPM list.

52. The device of claim 49, wherein the processor is further configured to:
select a first HIPM candidate from a plurality of HIPM candidates in the HIPM table;
determine an HIPM index configured to indicate the first HIPM candidate; and
encode the current block using the HIPM index.
